(19) United States
(12) Patent Application Publication
(10) Pub. No.: US 2007/0138370 A1
(43) Pub. Date: Jun. 21, 2007

(54) Disc Injection Mold and Related Cooling System Capable of Reducing Tracking Errors

(76) Inventors: Li-Wen Chung, Tao-Yuan Hsien (TW); Chia-Sheng Lin, Kao-Hsiung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/382,930

(22) Filed: May 12, 2006

(30) Foreign Application Priority Data
Dec. 19, 2005 (TW) 094145062

(51) Int. Cl. B29C 45/73

(52) U.S. Cl. 249/79; 425/552

(57) ABSTRACT

A disc injection mold includes a mirror block and a cooling system. The cooling system is formed on the mirror block. The cooling system includes a water path, an input port and an output port. The water path is formed on the mirror block. The input port is formed on the water path and located closer to an inner track of the mirror block than to an outer track of the mirror block for drawing cooling water into the water path. The output port is formed on the water path and located closer to the inner track of the mirror block than to the outer track of the mirror block for releasing cooling water from the water path.

### BACKGROUND OF THE INVENTION

1. Field of the Invention

The present invention relates to a disc injection mold and related cooling system capable of reducing tracking errors, and more particularly, to a disc injection mold which improves a water path formed on a mirror block.

2. Description of the Prior Art

With the development of optical storage technology and burning technology, the utility rate of various discs such as CD-R, CD-RW, DVD-R and DVD-RW increases day by day. Optical storage devices are provided with large storage capacity, reliable data, and portability. At the present day, CD discs and DVD discs have replaced traditional discs, tapes, and video discs. The size of a DVD disc is the same as a CD disc with a diameter of 12 cm. One DVD disc is composed of two discs with a thickness of 0.6 mm, and each side has a storage capacity of up to 4.7 GB. The maximum capacity of a DVD disc is up to 17 GB. DVD discs are divided into several standards, such as DVD-R, DVD-RW, DVD-RAM, DVD+R and DVD+RW according to different specifications.

A DVD disc is distinguished into a central blank block and an outer data block, wherein the data block is used to store data and be read via the read head of a disc machine or a burner. The DVD disc fails as soon as a data block is corrupt.

Please refer to FIG. 1. FIG. 1 is a diagram illustrating a disc manufacture procedure 10. The disc manufacture procedure 10 includes the following steps:

Step 11: substrate injection molding;

Step 12: dyes coating;

Step 13: drying;

Step 14: reflection layer sputtering;

Step 15: DVD combination; and

Step 16: label printing.

Step 11 is to produce a blank substrate with a recess by injection molding a plastic material. Step 12 is to coat organic dyes on the recess of the blank substrate, wherein the organic dyes form the storage layer of a disc. Step 14 is to form a metal film on the substrate as the reflection layer of the disc. Step 15 is to combine two substrates with each other. Finally, a DVD disc production is completed by printing the exterior label.

Please refer to FIG. 2. FIG. 2 is a diagram of a disc injection mold 20 according to the prior art. The disc injection mold 20 includes an mirror block 22 and a cooling system 25. The cooling system 25 is a re-circulating cooling system located on the mirror block 22. The cooling system 25 includes a water path 26, an input port 28 and an output port 29. The mirror block 22 is a circular mold and comprises stainless steel material. The mirror block 22 has an inner track 24 and an outer track 23. The input port 28 is formed on the water path 26 and located adjacent to the inner track 24 of the mirror block 22. The output port 29 is formed on the water path 26 and located adjacent to the outer track 23 of the mirror block 22. The disc injection mold 20 is used to produce a substrate of a DVD disc by forming a plastic substrate with a recess at high pressure and high temperature.

Please refer to FIG. 3. FIG. 3 is a cross-sectional view of a digital versatile disc 30 according to the prior art. The digital versatile disc 30 includes two plastic substrates 31 and 38. The plastic substrate 31 includes a substrate base 32, organic dyes 34, and a metal film 36. Firstly, the substrate base 32 with a recess 33 is created by injection molding a plastic material. After that, the organic dyes 34 are coated on the recess 33 of the substrate base 32, wherein the organic dyes 34 form the storage layer of the digital versatile disc 30. DVD-format signals are written into the digital versatile disc 30 by read modulating and write modulating laser signals. After drying, a metal film 36 is formed on the substrate base 32. Finally, the digital versatile disc 30 is completed by combining the plastic substrates 31 and 38 and printing the exterior label. However, a deformation phenomenon can occur in the recess 33 of the substrate base 32 due to unbalanced pressure. The deformation phenomenon usually happens adjacent to the output port 29 or the input port 28.

The cooling system 25 draws cooling water into the water path 26 via the input port 28 and releases the cooling water from the water path 26 via the output port 29. The system is cooled by re-circulating the cooling water continuously. In the prior art, the output port 29 is located adjacent to the outer track 23 of the mirror block 22 and bears more pressure (about 30 to 40 tons). Under a high-speed burning condition, the speed of the outer track is higher than the speed of the inner track. This can result in tracking errors, and more particularly, the tracking error problem is critical near the output port 29 of the water path 26.

### SUMMARY OF THE INVENTION

The present invention provides a disc injection mold capable of reducing tracking errors. The disc injection mold includes a mirror block and a cooling system. The cooling system is formed on the mirror block. The cooling system includes a water path, an input port and an output port. The water path is formed on the mirror block. The input port is formed on the water path and located closer to an inner track of the mirror block than to an outer track of the mirror block for drawing cooling water into the water path. The output port is formed on the water path and located closer to the inner track of the mirror block than to the outer track of the mirror block for releasing cooling water from the water path.

The present invention further provides a cooling system capable of reducing tracking errors of a disc injection mold. The cooling system includes a water path, an input port, and an output port. The water path is formed on a mirror block. The input port is formed on the water path and located closer to an inner track of the mirror block than to an outer track of the mirror block for drawing cooling water into the water path. The output port is formed on the water path and located closer to the inner track of the mirror block than to the outer track of the mirror block for releasing cooling water from the water path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a manufacturing procedure of a disc.

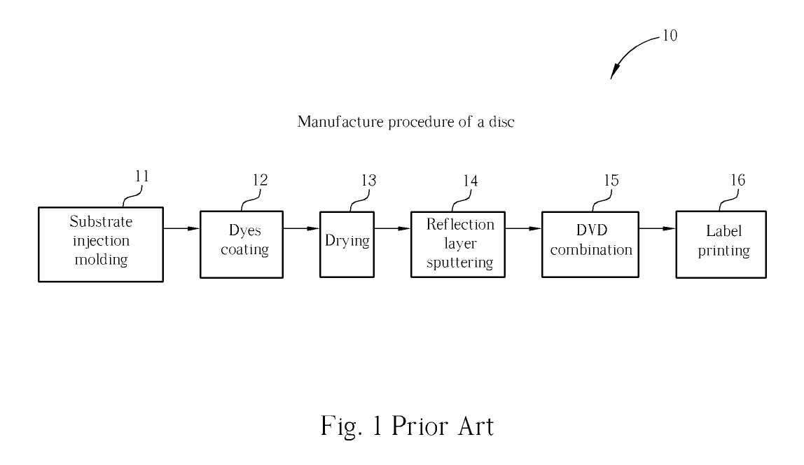

FIG. 2 is a diagram of a prior art disc injection mold.

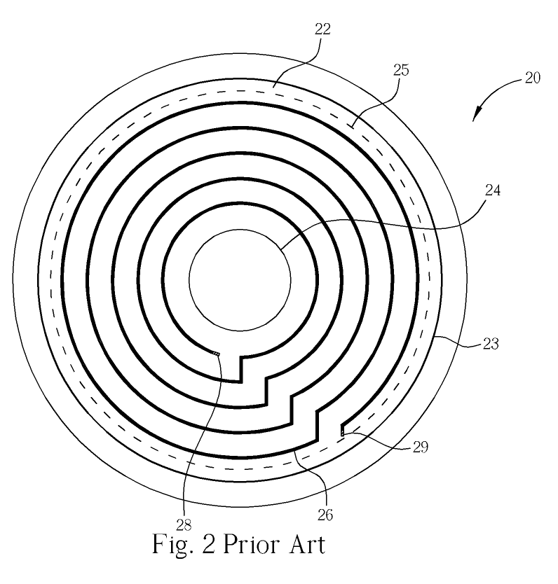

FIG. 3 is a cross-sectional view of a prior art digital versatile disc.

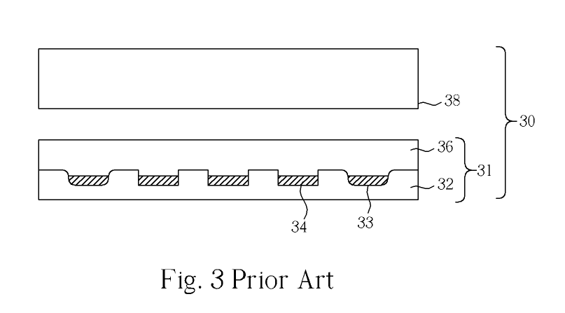

FIG. 4 is a diagram of a disc injection mold according to the present invention.

FIG. 5 is a diagram of a disc injection mold according to another embodiment of the present invention.

FIG. 6 is a cross-sectional view of a digital versatile disc according to the present invention.

### DETAILED DESCRIPTION

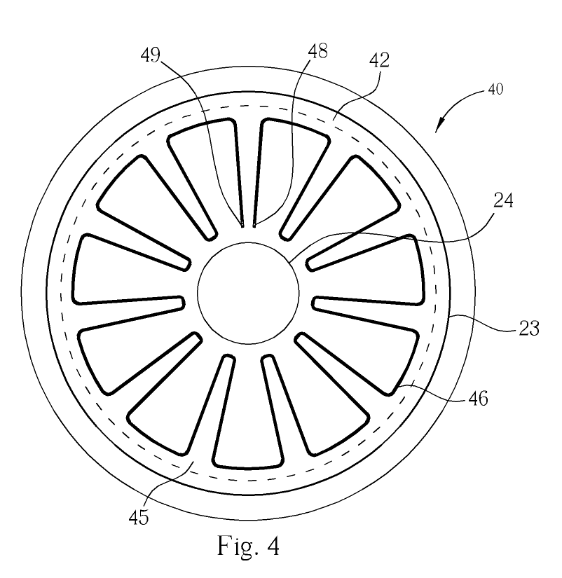

Please refer to FIG. 4. FIG. 4 is a diagram of a disc injection mold 40 according to an embodiment of the present invention. The disc injection mold 40 includes a mirror block 42 and a cooling system 45. The cooling system 45 is a re-circulating cooling system located on the mirror block 42. The cooling system 45 includes a water path 46, an input port 48, and an output port 49. The mirror block 42 is a circular mold and comprises stainless steel material. The mirror block 42 has an inner track 24 and an outer track 23. The input port 48 is formed on the water path 46 and located adjacent to the inner track 24 of the mirror block 42. The output port 49 is formed on the water path 46 and located adjacent to the outer track 23 of the mirror block 42. The disc injection mold 40 is used to produce a substrate of a DVD disc by forming a plastic substrate with a recess at high pressure and high temperature.

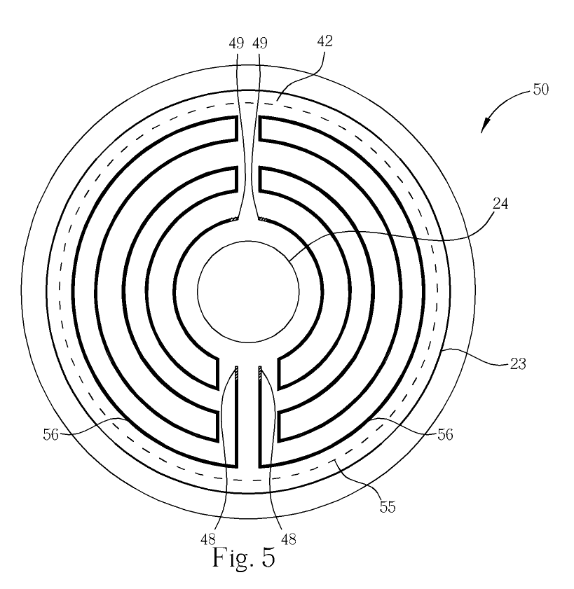

Please refer to FIG. 5. FIG. 5 is a diagram of a disc injection mold 50 according to another embodiment of the present invention. The disc injection mold 40 includes an mirror block 42 and a cooling system 55. The cooling system 55 is a re-circulating cooling system located on the mirror block 42. The cooling system 55 includes two water paths 56, two input ports 48, and two output ports 49. The mirror block 42 is a circular mold and comprises stainless steel material. The mirror block 42 has an inner track 24 and an outer track 23. The input port 48 is formed on the water path 56 and located adjacent to the inner track 24 of the mirror block 42. The output port 49 is formed on the water path 56 and located adjacent to the outer track 23 of the mirror block 42. The disc injection mold 50 is used to produce a substrate of a DVD disc by forming a plastic substrate with a recess at high pressure and high temperature.

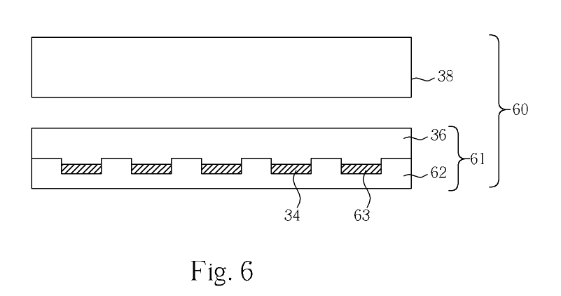

Please refer to FIG. 6. FIG. 6 is a cross-sectional view of a digital versatile disc 60 according to the present invention. The digital versatile disc 60 includes two plastic substrates 61 and 68. The plastic substrate 61 includes a substrate base 62, organic dyes 34, and a metal film 36. Firstly, the substrate base 62 with a recess 63 is created by injection molding a plastic material. After that, the organic dyes 34 are coated on the recess 63 of the substrate base 62, wherein the organic dyes 34 form the storage layer of the digital versatile disc 60. DVD-format signals are written into the digital versatile disc 60 by read modulating and write modulating laser signals. After drying, a metal film 36 is formed on the substrate base 62. Finally, the digital versatile disc 60 is completed by combining the plastic substrates 61 and 68 and printing the exterior label. No deformation phenomenon occurs in the recess 63 of the substrate base 62 because both the output port 49 and the input port 48 are located adjacent to the inner track 24 of the mirror block 42.

The above-mentioned embodiments illustrate but do not limit the present invention. The shapes of the water paths 46 and 56 are not limited, and they can also be other shapes. The present invention concerns placing both the input port 48 and the output port 49 adjacent to the inner track 24 of the mirror block 42.

In conclusion, the present invention provides disc injection molds 40 and 50 capable of reducing tracking errors. The input port 48 and the output port 49 of the water path are located adjacent to the inner track 24 of the mirror block 42. Although the portion closer to the input port 48 and the output port 49 bears more pressure and is deformed, at a high-speed burning condition, tracking errors can be avoided in the outer track 23. With the improvement of the water path design, tracking errors can be improved, and then the burning rate and the yield rate of a DVD disc can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A disc injection mold capable of reducing tracking errors comprising:
a mirror block; and
a cooling system formed on the mirror block and comprising:
a water path formed on the mirror block;
an input port formed on the water path and located closer to an inner track of the mirror block than to an outer track of the mirror block for drawing cooling water into the water path; and
an output port formed on the water path and located closer to the inner track of the mirror block than to the outer track of the mirror block for releasing cooling water from the water path.

2. The disc injection mold of claim 1 wherein the mirror block is a circular mold.

3. The disc injection mold of claim 1 wherein the mirror block comprises stainless steel material.

4. The disc injection mold of claim 1 wherein the disc injection mold is used for producing a substrate of a high speed digital versatile disc.

5. The disc injection mold of claim 1 wherein the cooling system is a re-circulating cooling system.

6. The disc injection mold of claim 1 wherein the input port is formed adjacent to the inner track of the mirror block.

7. The disc injection mold of claim 1 wherein the output port is formed adjacent to the inner track of the mirror block.

8. The disc injection mold of claim 1 wherein the input port and the output port are formed at two different ends of the water path.

9. A cooling system capable of reducing tracking errors of a disc injection mold comprising:
a water path formed on a mirror block;
an input port formed on the water path and located closer to an inner track of the mirror block than to an outer track of the mirror block for drawing cooling water into the water path; and
an output port, formed on the water path and located closer to the inner track of the mirror block than to the outer track of the mirror block for releasing cooling water from the water path.

10. The cooling system of claim 9 is a re-circulating cooling system.

11. The cooling system of claim 9 wherein the input port is formed adjacent to the inner track of the mirror block.

12. The cooling system of claim 9 wherein the output port is formed adjacent to the inner track of the mirror block.

13. The cooling system of claim 9 wherein the input port and the output port are formed at two different ends of the water path.
